(19) United States
(12) Patent Application Publication
(10) Pub. No.: US 2023/0401262 A1
(43) Pub. Date: Dec. 14, 2023

(54) QUANTUM-INSPIRED METHOD AND SYSTEM FOR CLUSTERING OF DATA

(71) Applicant: Multiverse Computing SL, San Sebastian (ES)

(72) Inventors: Román Oscar Orús Lacort, SAN SEBASTIÁN (ES); Pablo Bermejo, SAN SEBASTIÁN (ES)

(21) Appl. No.: 17/837,469

(22) Filed: Jun. 10, 2022

(51) Int. Cl. G06F 16/906

(52) U.S. Cl. CPC G06F 16/906

(57) ABSTRACT

A computer-implemented method for establishing clusters for a set of data points in a data set is described. The method comprises in a first step a building of a cost function for the data points in the form of a Hamiltonian, followed by creating from the cost function a tensor network comprising a plurality of tensors. The tensor network is subsequently passed to a processor for performing algebraic operations on the tensors in the tensor network using the processor to update iteratively the tensors in the tensor network. Finally, the method comprises outputting the updated tensors. The cluster into which the data points are clustered and be determined from the parameters of the updated tensors in the tensor network.

### CROSS-REFERENCE TO RELATED APPLICATIONS

None

### BACKGROUND OF THE INVENTION

### Field of the Invention

The field of the invention relates to a method and system for clustering of data.

### Brief Description of the Related Art

Machine learning (ML) is the development of computer algorithms that can improve automatically through experience and using large collections of data. The machine learning algorithms construct a model based on sample data, known as training data, to make predictions or decisions based on new sets of data without being explicitly programmed to do so. The machine learning algorithms are used in a wide variety of applications, such as in medicine, email filtering, speech recognition, process engineering and computer vision, where it is difficult or unfeasible to develop conventional algorithms to perform the needed tasks.

Machine learning approaches are essentially divided into three broad categories of approaches which depending on the nature of the feedback available to the learning system. In supervised learning approaches, the training model for the algorithm is presented with example inputs to which labels have been attached and their desired outputs. The goal of the supervised learning model is to learn a general rule that maps input data to outputs.

In unsupervised learning approaches, no labels are given to the data used in the learning algorithm and the learning algorithm attempts to find structure in the input data. The unsupervised learning can be used for discovering hidden patterns in data or for identifying and learning new features in the data.

Reinforcement learning uses a computer program interacting with a dynamic environment in which the computer program must perform a certain goal. As the computer program navigates through its problem space, the learning algorithm for the model is provided with feedback in the form of rewards and the learning algorithm tries to maximize the rewards.

These three approaches are used extensively for different application and a focus area relies on improving the different machine learning algorithms based on a training procedure. There are times in which there is no clue for patterns in the data set to be studied, and there is no indication to relate the data set to any other previously known data set. It is expected that as society gathers more data, this type of opaqueness will increase.

There is therefore a need to develop methods and systems to process the data sets and identify patterns within the data sets. One of the ways to identify patterns within the data sets is clustering. The concept of clustering includes a task of dividing a population or data points in the datasets into a number of different clusters based on similarities among the properties of the data points. In other words, the clustered data points in one of the clusters are like the data points in the same cluster and dissimilar to the data points in other ones of the clusters.

The concept of clustering has many applications in the field of data mining, such as in surveillance, intrusion detection in cyber security, fraud detection for credit cards, insurance or health care, industrial processes, and fault detection in safety critical systems.

Quantum-inspired methods of data clustering are known in the art. For example, U.S. Pat. No. 8,874,412 (Weinstein et al) teaches the clustering of a set of data points. Initial states are defined, where each of the initial states is centered on a corresponding one of the data points. A potential function is determined such that a quantum mechanical ground state of the potential function is equal to a sum of the initial states. A trajectory for each of the data points is computed according to quantum mechanical time evolution of the initial states in the potential function.

U.S. Pat. No. 10,169,445 (Weinstein et al) teaches another method of clustering data by pre-processing a set of data points. Initial states are defined, where each of the initial states is centered on a corresponding one of the data points. A potential function is determined such that a quantum mechanical ground state of the potential function is equal to a sum of the initial states. A trajectory for each of the data points is computed according to quantum mechanical time evolution of the initial states in the potential function. Information derived from the trajectories is displayed.

U.S. Pat. No. 11,288,540 (Mandal et al) teaches a method which involves receiving a set of data points for an integrated clustering and outlier detection and receiving a user input that indicates a number of outlier data points to be detected from the received set of data points, and thus ensures simple and efficient operation of the optimization solver machine.

### BRIEF SUMMARY OF THE INVENTION

The method and system set out in this document describe a clustering for data in a data set and processing the data using a hybrid quantum and quantum-inspired approach. The idea is to express the clustering problem in terms of a geometric optimization, which is subsequently solved using tensor network optimization methods, possibly enhanced by quantum algorithms in some key linear algebra manipulations.

In one aspect, a computer-implemented method for establishing clusters for a set of data points in a data set is described. The method comprises in a first step a building of a cost function for the data points in the form of a Hamiltonian, followed by creating from the cost function a tensor network comprising a plurality of tensors. The tensor network is subsequently passed to a processor for performing algebraic operations on the tensors in the tensor network using the processor to update iteratively the tensors in the tensor network. Finally, the method comprises outputting the updated tensors. The cluster into which the data points are clustered and be determined from the parameters of the updated tensors in the tensor network.

The performing of the algebraic operations on the tensors has the goal of establishing an energy minimum for the tensor network.

The method is concluded during the iterative updating of the tensors concludes when one of the following conditions is reached: all of the coefficients of the tensors have been updated at least once. a predefined number of iterations or a convergence criterion is reached. It is also possible to change precision parameters of the tensor network.

The method can be used for clustering datasets of at least one of financial data, sensor data, vision data, language processing data, or health data.

A system for establishing clusters for a set of data points in a data set is also disclosed. The system comprises a data storage unit for storing the data set, a central processing unit for calculating the distances (e.g., Euclidean distances) between the data points in the data set and constructing a cost function from the distances. In one example, a quantum processor (including an emulator) is provided for receiving the cost function from the central processing unit (20) and solving the cost function to identify a minimum in the cost function. The quantum processor could be a quantum annealing processor.

### DESCRIPTION OF THE FIGURES

For a more complete understanding of the present invention and the advantages thereof, reference is now made to the following description and the accompanying drawings, in which:

FIG. 1 shows an overview of a computing system for implementing a method in accordance with a preferred embodiment of the present invention.

FIG. 2 is a flow chart illustrating a method in accordance with a preferred embodiment of the present invention.

### DETAILED DESCRIPTION OF THE INVENTION

The invention will now be described with reference to the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

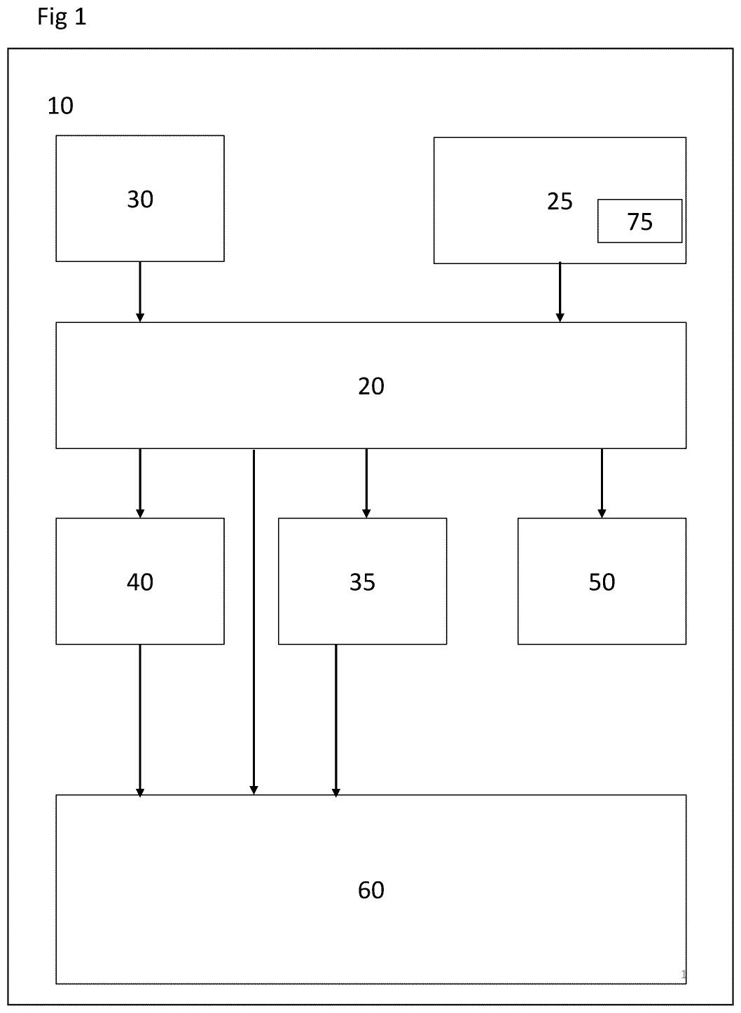

FIG. 1 shows an overview of a computing system 10 for implementing the method of this document. The computing system 10 is a hybrid quantum and classical system and comprises, in an example, a central processing unit 20 which is connected to a data storage unit 25 (i.e., one or more memory devices), and input/output devices 30. A graphics processing unit 35 for processing vector calculations and a field programmable gate array (FGPA) 40 for control logic are connected to the central processing unit 20. A quantum processor 50 (also termed quantum accelerator) is connected to the central processing unit 20. The data storage unit 25 comprises one or more memory devices 75, such as solid-state memory or disk memory, that can store a data set that is used for storing the data on which the method is run.

In one implementation of the computing system 10, the quantum processor 50 can be a noisy intermediate-scale quantum processor, but this is not limiting of the invention. The computing system 10 is connected to a computer network 60, such as the Internet. It will be appreciated that the computing system 10 of FIG. 1 is merely exemplary and other units or elements may be present in the computing system 10. It will also be appreciated that there may be many input/output (I/O) devices 30 located at multiple locations and that there may be a plurality of data storage units 25 also located at multiple locations. The many I/O devices and data storage units 25 are connected by the computer network 60.

In this document, the structure of data stored in the data storage unit 25 is assumed to be unknown or opaque. The data set could be, for example, two-dimension or more dimensional data relating to medical statistics, industrial processes, financial data, or be an unstructured data set. The idea behind the method is to express the clustering problem in terms of a geometric optimization, which is subsequently solved using tensor network optimization methods, and can be enhanced by using quantum algorithms in some linear algebra manipulations.

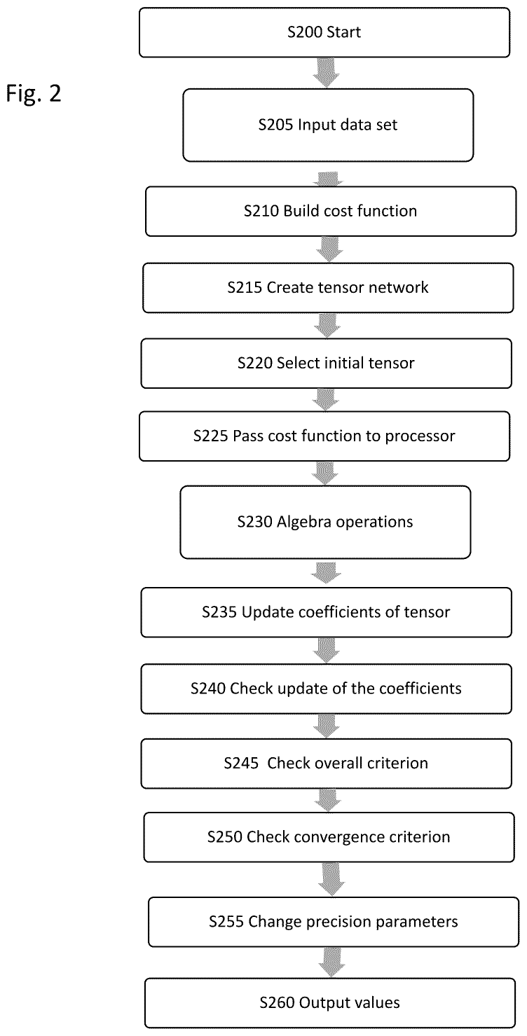

FIG. 2 shows a flow diagram of the method.

The method starts at S200, and a data set is input in step S205 into the data storage unit 25. The data set can be unstructured, and it is possible that nothing is known about the properties of data points in the data set. This data set is opaque and, at least in some case, there is no possibility to use a pre-trained data to predict the behavior of the data set input in the step S205.

Non-limiting examples of such data sets are two-dimensional or more-dimensional distributions of certain characteristics. For example, the data sets could include financial data to enable conclusions to be drawn from the clusters. Another non-limiting example would be in finance in which the data set is the set of points of all taxpayers in a given geometrical space, so that it would be possible to cluster the data points into different groups and detect therefore anomalies that could correspond to potential tax-fraudsters. Another example could be in artificial vision systems, in which the data points correspond to different objects are clustered together corresponding to specific visual patterns (e.g., faces, books, etc.).

This system could also be implemented in autonomous vehicles to recognize different agents (pedestrians, traffic lights . . . ) and take subsequent decisions automatically. Another example could be data from speech recognition systems, where the input corresponds to words and they could be aggregated in a geometrical space so that, for instance, different words correspond to different linguistic elements such as nouns, verbs, and so on are identified and the correct context chosen.

The method set out in this document is to endeavor to obtain insights into the data set and the information contained within this data set. One insight is obtained by performing clustering on the data points in the data set in such a way that the data points within the data set are assigned to one and only one possible family of data points (also termed a “cluster”). Commonly, this relationship between the data points is based in the proximity of the data points (e.g., measured as a Euclidean distance or other type of distance) belonging to the same family. The Euclidean distance between the data points in the dataset is calculated in S207.

To find an optimum configuration of a given system, it is necessary to build in step S210 a cost function having a minimum at the point in which the configuration of the system is optimum. In other words, one must quantify the data in the data set and shape a function capable of serving as a route map for the data points in the data set to end up belonging to the families/clusters that minimize the cost function.

The cost function to establish this minimum is constructed according to the distances between the different data points, being the data points represented in a geometric space.

The cost function is a Hamiltonian structure which is designed to perform clustering on the data set and can be constructed in the central processing unit. The Hamiltonian takes the following form for this specific algorithm using tensor networks:

$$H = {\sum }_{i > j}^{N} d ( {x}_{i} , {x}_{j} ) h ( {n}_{i} , {n}_{j} )$$

This represents the processing of clustering the data points xi with i=∈[1, N], d(xi, xj) is the distance between two data points and N is the total number of data points,

The two-body operator h(nᵢ, nⱼ) is defined as

$$h ( {n}_{i} , {n}_{j} ) = \{ \begin{matrix}{δ}_{{n}_{i} , {n}_{j}} , & if d ( {x}_{i} , {x}_{j} ) \leq ϵ \\ 1 - {δ}_{{n}_{i} , {n}_{j}} , & if d ( {x}_{i} , {x}_{j} ) > ϵ\end{matrix}$$

with nᵢ=0, 1, . . . , k−1=and is a variable for each data point i labelling the cluster to which it belongs, k is the number of clusters, and e a distance cutoff that is a fine-tuning parameter to define the geometric size of the cluster and can, if required, be set by the user or automatically to adjust the size of the clusters.

The cost function H above is a particular case of a Potts model which is defined in terms of Potts variables nᵢ that label the different clusters. The cost function is developed such that data points i which are sufficiently close tend to be in the same cluster. The data points i which are far away tend to be in different clusters. The ground state of the model provides the cluster label nᵢ for each data point xi. This clustering depends on the fine-tuning parameter e, defining the size of the clusters. Notice also that this cost function can be fine-tuned in different ways, by adding different types of regularization parameters.

The cost function H can be optimized using a method based on tensor networks (TN) that can be accelerated using quantum processors. The method is based on two main modules which can be implemented in one or more of the “classical” central processing units 20, the graphics processing unit 35, the field programmable gate array 40, and/or the quantum processor 50. It will be appreciated that an emulator can be used instead of a true quantum processor.

The first module is a solver module, and the second module is an update module. The solver module admits as an input the description of the cost function H and has as an output a proposal for solution. The solver module comprises different internal steps.

In a first step S215, an initial tensor network (TN) representing the lowest-cost configuration of the cost function H is created and stored in the data storage unit 25. The lowest-cost configuration of the cost function will be the ground state of the cost function H in which the eigenvector of H has the lowest eigenvalue. This TN is a representation of a vector in a multidimensional vector space which is spanned by all possible configurations of the problem variables. The TN has an inner structure in terms of tensors correlated in some specific way. The specific TN is chosen according to the peculiarities of the problem, such as geometry and expected density of quasi-optimal solutions. A non-limiting example of such a tensor network could be, for instance, a Matrix Product State, or Tensor Train, which corresponds to a one-dimensional array of tensors. Other implementations of the tensor network would involve hierarchical structures such as Tree Tensor Networks, or higher-dimensional structures, such as Projected Entangled Pair States, in which the tensors are arranged according to patterns in more than one dimension. In any of these implementations, the optimization procedures to follow are similar, and vary in detail such as the consideration of loops in the network, and the implementation of different approximation parameters.

In the next step S220, an initial tensor i is chosen. There is generally no preferred initial tensor i. The initial tensor i is passed to one of the processors in step S225 and in the following step S230, algebraic operations are carried out on the tensor so that the coefficients of the chosen tensor i are updated in step S235 in such a way that the value of the cost function H is minimized. There are different algebraic operations that can be carried out to find the minimum. Non-limiting examples include variational, imaginary time evolution and tangent-space methods. In all the options, however, the update makes use always of linear algebra operations such as Singular Value Decomposition (SVD), Exact Diagonalization (ED), Principal Component Analysis (PCA), and Matrix Multiplication (MM). These linear algebra operations are in the prior art the bottleneck of the method, since the linear algebra operations are iteratively repeated many thousands of times throughout the whole algorithm following the three nested loops in the next steps of the Solver Module.

As will be explained later, these manipulations can be implemented on a classical processor (CPU, GPU, FPGA), or on a quantum processor (QPU) 50. The manipulation on the quantum processor 50 offers then extra efficiency. This will be explained in detail when we consider the update module.

In the next step S240, a check is carried out to see if all of the tensors in the TN have been updated following a predefined criterion. Usually, this criterion is that all of the tensors in the TN have been updated sequentially once or twice. If the sweep criteria are fulfilled, the method proceeds to the next step S245. If not, it changes the tensor to be updated and proceeds back to step S235.

At the following step S245 a check is carried to see if an overall criterion has been fulfilled. This overall criterion is typically whether the system has reached a predefined number of iterations of the previous steps S230 and S235 or not, or whether certain parameters have reached a predefined convergence or not. If the system has not reached a predefined number of iterations, the system goes back to step S230. If the system has reached a predefined number of iterations, the system continues to step S250.

Finally, in the step S250, a check is carried out to see if the system has reached a global predefined convergence criterion, so that the current result may be close to a near optimal solution of the optimization problem. If the system has not reached a global predefined convergence criterion, the system increments precision by changing the precision parameters of the update module in step S255. These precision parameters could be one or more of bond dimension of the TN, unit cell of the TN, number of iterations in the previous steps, Trotter-step in imaginary-time evolution, error tolerance in the linear algebra subroutines, and more. Usually, only TN-dependent parameters are modified. If the system has reached a global predefined convergence criterion, the system continues and provides an output in step S260 that corresponds to the proposed optimal configuration in the Main Module. This output S260 is carried out by reading the configuration of the variables “n” that minimizes the cost function H. It is possible then to determine in which one of the clusters, each of the data points belong. So, for example, if nᵢ=3, it means that the data point “i” falls into cluster 3.

The update module comprises subroutines and functions that update the tensors in the step S240 of the solver module. These functions involve linear algebra operations such as SVD, ED, PCA, MM, and more. These linear algebra operations can be carried out in either the classical processor, such as a CPU, a GPU, an FPGA, or a combination of all of them, including HPC resources for parallelization and acceleration. Alternatively, the linear algebra operations can be carried out on the quantum processor 50, using quantum linear algebra algorithms such as quantum-SVD, quantum ED, quantum-PCA and quantum-MM. Using the quantum processors 50 at this step allows for more efficiency as compared to classical algorithms, with an exponential improvement for very large objects. In practice, even a tiny acceleration at the step S240 involves a large overall acceleration, since these operations are repeated many times in the system following the procedure in the solver module.

It will be appreciated that the two options could work independently (classical or quantum), or also in combination (classical and quantum). The options could also work in individual processors (e.g., CPU, QPU) or in clusters of processors running different operations in parallel (HPC, clusters of QPUs). When running in parallel, the hardware architecture of each individual classical and/or quantum processor 50 could be different or not. For instance, one could use a cluster of QPUs all of them based on superconducting quantum circuits or use a cluster of QPUs with different hardware such as superconducting, photonic, ion-trap and neutral atoms.

### REFERENCE NUMERALS

10 Computing system
20 Central processing unit
25 Data storage unit
30 Input/output devices
35 Graphics processing unit
40 Field programmable gate array
50 Quantum processor
55 Input devices
60 Computer network
75 Memory unit

What is claimed is:

1. A computer-implemented method for establishing clusters for a set of data points in a data set, the method comprising:
building a cost function for the data points in the form of a Hamiltonian;
creating from the cost function a tensor network comprising a plurality of tensors;
passing the tensor network to a processor;
performing algebraic operations on the tensors in the tensor network using the processor to update iteratively the tensors in the tensor network; and
outputting the updated tensors.

2. The method of claim 1, wherein the performing of the algebraic operations on the tensors establishes an energy minimum for the tensor network.

3. The method of claim 1, wherein the iterative updating of the tensors concludes when all of the coefficients of the tensors have been updated at least once.

4. The method of claim 1, wherein the iterative updating concludes after a predefined number of iterations.

5. The method of claim 1, wherein the iterative updating concludes after reaching a convergence criterion.

6. The method of claim 1, further comprising changing precision parameters of the tensor network.

7. The method of claim 1 wherein the datasets are at least one of financial data, sensor data, vision data, language processing data, or health data.

8. A computer program product comprising instructions for implementing the method of claim 1.

9. A system for establishing clusters for a set of data points in a data set, the system comprising:
a data storage unit for storing the data set;
a central processing unit for calculating the Euclidean distances between the data points in the data set and constructing a cost function from the Euclidean distances;
a quantum processor for receiving the cost function from the central processing unit and solving the cost function to identify a minimum in the cost function.

10. The system of claim 9, wherein the quantum processor is a quantum annealing processor.
